(19) United States
(12) Patent Application Publication
(10) Pub. No.: US 2007/0061206 A1
(43) Pub. Date: Mar. 15, 2007

(54) System and method for providing rapid rebate payments

(76) Inventor: Dale LeFebvre, Dallas, TX (US)

Correspondence Address: SPRINKLE IP LAW GROUP, 1301 W. 25TH STREET, SUITE 408, AUSTIN, TX, 78705, US

(21) Appl. No.: 11/544,322

(22) Filed: Oct. 6, 2006

Related U.S. Application Data
(63) Continuation-in-part of application No. 11/504,122, filed on Aug. 15, 2006.
(60) Provisional application No. 60/724,088, filed on Oct. 6, 2005.
(60) Provisional application No. 60/708,219, filed on Aug. 15, 2005.
(60) Provisional application No. 60/728,278, filed on Oct. 19, 2005.
(60) Provisional application No. 60/777,583, filed on Feb. 28, 2006.

(51) Int. Cl. G06Q 30/00

(52) U.S. Cl. 705/14

(57) ABSTRACT

Embodiments of the invention provide a method and system that has the ability to allow consumers to process rebates on-line and receive the rebate on an accelerated basis in exchange for assigning the rebate to a third party. One embodiment of the invention provides the consumer with a disbursement option to accept less than the original rebate amount from the rebate sponsor in exchange for a significant reduction in time to collect the rest. The exchange can be done transparent to the rebate sponsor. Another embodiment of the invention provides the consumer with an assignment option to transfer the right to collect the rebate to a third party in exchange for a rapid payment. In this embodiment, the third party manages the collection of the rebate from the rebate sponsor.

### CROSS-REFERENCE TO RELATED APPLICATION(S)

The present application claims priority from U.S. Provisional Patent Application No. 60/724,088, filed Oct. 6, 2005, entitled “SYSTEM AND METHOD FOR PROVIDING RAPID REBATE PAYMENTS,” the entire content of which is incorporated herein by reference for all purposes. The present application also relates to U.S. patent application Ser. No. 11/504,122, filed Aug. 15, 2006, entitled “REBATE CROSS-SELL NETWORK AND SYSTEMS AND METHODS IMPLEMENTING THE SAME,” which claims priority from U.S. Provisional Patent Applications No. 60/708,219, filed Aug. 15, 2005, entitled “SYSTEM AND METHOD FOR SECURE INTEGRATION OF OFFERS IN A COMPUTER-AIDED REBATE PROCESSING SYSTEM,” No. 60/728,278, filed Oct. 19, 2005, entitled “SYSTEM AND METHOD FOR ESTABLISHMENT OF A REBATE CROSS-SELL NETWORK,” and No. 60/777,583, filed Feb. 28, 2006, entitled “SYSTEM AND METHOD FOR REAL TIME CROSS-SELLING OVER A NETWORK,” all of which are hereby fully incorporated herein by reference for all purposes.

### FIELD OF THE INVENTION

This invention relates generally to fulfillment of consumer product rebates. More particularly, embodiments of the present invention relate to a system and method for constructing, arranging, and/or facilitating rapid rebates in an electronic rebate processing progression and presenting them as disbursement options to consumers seeking rebate redemption in a manner that can be transparent to the rebate sponsor(s).

### BACKGROUND OF THE RELATED ART

Rebate sponsors offer rebates to entice price conscious consumers to make purchases. Currently, there are numerous rebate models in the marketplace. These models can generally be segmented into two categories; instant rebates and post-chase rebates. An instant rebate can be automatically applied by the merchant at the point of sale. A post-purchase rebate can be claimed subsequent to the purchase of a rebate-qualifying product. Instant rebates can be viewed as a way of presenting a simple price reduction that implies that the reduction may only be offered for a limited period of time, thereby enticing the consumer to make a timely purchase. Post-purchase rebates require a consumer to pay full price for a product at the time of purchase, and to provide some information to obtain the rebate afterwards. Typically, the rebate payment is disbursed to the consumer only if the consumer has indeed made a rebate eligible purchase, submitted all the required information, and complied with all the terms and conditions associated with the particular rebate program.

Traditionally, the majority of the conventional, post-purchase rebates require that the consumer mail in a rebate claim form complete with consumer information, along with certain rebate collateral or proof of purchase, typically including the original sales receipt and the UPC code from the product packaging. Today, although the majority of post-purchase rebates still require the consumer to mail in the rebate claim form with some form of proof of purchase, additional processes have been developed that now allow for post-purchase rebate claims to be initiated online (e.g., through the World Wide Web). Some rebate sponsors even adopted a completely paperless process that leverages a unique rebate claim code generated at the point-of-sale. These more efficient, electronic rebate submission models can in some cases cut down the initial time involved in submitting rebate claims.

One example of such a computer-aided rebate processing system is disclosed in U.S. Pat. No. 6,847,935, issued to Solomon et al. The system of Solomon et al. includes a networked rebate processing center which allows a consumer who purchased a rebate-qualifying product to fill out an online rebate request form through the rebate processing center's processing interface. After the rebate request is successfully processed, the consumer may be given several disbursement options (e.g., cash, gift certificate, manufacturer credit, etc.). Submitting the rebate request form to and receiving the disbursement options from the rebate processing center can be viewed as two separate transactions. The former transaction can be initiated by the consumer electronically or by mail. To maintain breakage and prevent fraudulent claims, the system of Solomon et al. requires the consumer to print and mail the completed rebate request form affixed with a receipt and a UPC symbol. Solomon et al. suggests that a secure technique could be used to verify the authenticity of a purchase, obviating the need for a paper transmittal.

Still, regardless of the manner in which a rebate claim is initiated and/or submitted, consumers generally must wait six to ten weeks between filing the rebate claim and receiving their rebate payment. To illustrate this point further, consider a rebate processing timeline that starts when the rebate claim form and required rebate collateral from the consumer are received by a rebate processor or processing center through the mail or via the Web (e.g., the consumer initiates a rebate redemption process through a Web site of or managed by the rebate processor) and ends when the rebate payment is received by the consumer. Generally, there are several phases between the starting point and the end point of this rebate processing timeline:

Phase 1: Rebate authorization, 3-5 days;

Phase 2: Invoicing, 2-5 days;

Phase 3: Invoice payment, 4-6 weeks;

Phase 4: Check/payment processing, 1 week; and

Phase 5: Disbursement, 3-5 days.

More specifically, it may take three to five days for the rebate processor to enter the information in a database, process the data entered, and determine whether the consumer's submission satisfies all the terms and conditions under the associated rebate program. Next, it may take two to five days for the rebate processor to generate and send an invoice to the rebate sponsor based on the rebate claim submitted by the consumer. Thereafter, it may take four to six weeks for the rebate sponsor to evaluate the invoice from the rebate sponsor, enter and verify the information, process the invoice, provide appropriate fund(s) as payment for the amount invoiced, and send the invoice payment to the rebate processor. Then, it may take another week for the rebate processor to initiate a process to have an appropriate check cut for the amount of rebate requested by the consumer. Finally, it may take three to five days for the rebate processor to mail the check to the consumer. As this rebate processing timeline demonstrates, the whole process generally takes about six to ten weeks.

In spite of the consumer's natural desire to receive the rebate payment as quickly and as conveniently as possible, a significant percentage of consumers making rebate eligible purchases either do not claim the rebate at all or fail to meet the rebate sponsor's terms and conditions. The latter is a result of clever designs built into the traditional rebate models which tend to embed breakage points in the rebate redemption process. The six to ten weeks rebate processing timeline allows the rebate sponsors and rebate processors to structure rebate program requirements which provide multiple opportunities for a consumer to fail to comply. These consumer compliance requirements generate “breakage,” where rebate-eligible products are sold and the associated rebates are not successfully claimed. As an example, in the aforementioned U.S. Pat. No. 6,847,935, to provide opportunities for breakage, Solomon et al. envision that the rebate processing system would maintain numerous post purchase requirements so that a consumer would still need to go through a myriad of processes to realize a rebate. Any number of steps may halt or suspend rebate processing to wait for further actions by the user (e.g., submission of verifying materials such as receipts or UPC symbols, etc.). The rebate processing center may terminate processing at points of breakage (e.g., failed communications, failure to meet the promotion requirements, failure to submit the verifying materials, etc.) without notifying the consumer of the status.

As the above example illustrates, there is not much the consumer can do to speed up the rebate redemption process. Moreover, there is little, if any, incentive for rebate sponsors as well as rebate processors to significantly reduce the rebate processing time. EMO Corp. of Texas, now in receivership, had attempted to offer qualified rebate recipients a fee-based approach to replace the check-in-the-mail disbursement option. Specifically, an email is sent to each qualified rebate recipient in the disbursement phase. The email invites the qualified rebate recipient to print their check on their plain paper printer. The qualified rebate recipient may accept or decline the offer. If accepted, a portion of the rebate is deducted (e.g., $2 fee for a $50 rebate check) before the check is printed.

EMO's fee-based rebate check printing service is analogous to the basic idea of PayPal® wherein electronic payments to and from the electronic accounts of individuals and entities alike may be realized through a third party service provider (i.e., PayPal®) and wherein transaction fees are deducted from payments made. Unfortunately, both the EMO and basic PayPal® solutions only address the delay associated with traditional postal mail delivery in the disbursement phase. They do not address the delay in the overall rebate payment process or the steps (phases) that lead to the largest portion of the delay in the overall rebate payment process.

A need exists for ways to enable rebate sponsors to fulfill rebates more accurately and deliver the promised value to consumers more quickly. Embodiments of the present invention address this need and more.

### SUMMARY OF THE INVENTION

Embodiments of the present invention provide a rapid rebate processing system and method that can significantly shorten the time from rebate authorization to receipt of funds by the consumer. Specifically, embodiments of the present invention can electronically provide a rapid rebate that is less than the face value of the original, authorized rebate, that can be processed entirely online, and that can be redeemed in as little as one day or less. Even more specifically, embodiments of the present invention can enable a factoring company to purchase rebate receivables from consumers below par and redeem those rebate receivables at a higher or face value utilizing a process that is transparent to the rebate sponsor.

Embodiments of the present invention can provide multiple mechanisms for enabling and subsequently fulfilling a rapid rebate offer made to a consumer. The system and method of the current invention includes at least the following rapid rebate enablement mechanisms: (1) purchase of rebate receivables, (2) assessment of a convenience fee, and (3) a short-term consumer loan. Independent of which enabling mechanism is employed, the rapid rebate can be sent to the consumer via any funds disbursement/transfer mechanism, including but not limited to (1) providing a direct deposit into the consumer's account (e.g., checking, savings, PayPal®, etc.), (2) mailing the consumer a check or pre-paid card, and (3) providing a credit to the consumer's credit or debit card. Such a credit may be a rebate credit that can be used to purchase additional goods and/or services.

Purchase Receivable

In one embodiment, the rapid rebate is enabled through the purchase of a rebate receivable from the consumer. In this embodiment, the rebate is purchased from the consumer for less than the original rebate amount and the consumer is offered one or more of the following disbursement options: 1) cash transfer into the consumer's account; 2) credit applied to the consumer's credit card; or 3) other expedited cash availability mechanism. The invention can include a system that enables a financial institution or factoring company with physical and electronic relationships throughout the Rebate Supply and Demand Chain, to purchase rebate receivables from consumers at a discount to face value, in exchange for making funds available to the consumer on an expedited basis. By treating the authorized rebate as a receivable, the factoring company can provide a rapid rebate without creating a consumer credit facility, loan servicing obligations, or underwriting.

Embodiments of the current invention allows the consumer to enter into a purchase agreement with the factoring company, wherein the consumer agrees to sell the existing or pending rebate receivable to the factoring company at an agreed upon price, which is less than the par (face) value of the receivable, and the factoring company agrees to electronically deposit the purchase price of the receivable into an account designated by the consumer within 24-48 hours after receiving a confirmation of rebate authorization from the rebate processor, send a check, or disburse funds through another available expedited cash availability mechanism. Consistent with the purchase agreement, once the rapid rebate payment has been made, the factoring company (purchaser) assumes all of the credit risk associated with the outstanding rebate receivable. Unlike refund anticipation loans, which are secured by the taxpayer's expected refund, the consumer does not bear any continuing liability associated with the rebate receivable.

Upon receipt of the rapid rebate request, inclusive of a confirmation of rebate authorization, the electronic purchase agreement or a confirmation of the consumer's electronic signature, and the consumer's disbursement data, from the rebate processor, the factoring company can then create or designate an account into which the rebate funds can be electronically deposited by the rebate processor after the rebate sponsor pays the associated invoice or provides funds through an alternative credit facility.

Because the rapid rebate is a disbursement option that does not have to be presented to the consumer until after the rebate has been claimed, its availability does not necessarily have any impact on the consumer's decision to submit a rebate request. Additionally, even if only the consumer of record is legally entitled to the rebate, the rapid rebate approach still works, as the rebate remains to be claimed by the consumer of record, creating the receivable that is then sold to the factoring company. Alternatively, the original rebate payment can be deposited into an account that is in the name of the consumer claiming the rebate.

By enabling a factoring company to purchase discrete rebate receivables from consumers during electronic rebate processing, the rapid rebate approach would create a large scale, secondary market for consumer product rebate receivables that does not exist in the current rebate processing environment. By creating an account into which a rebate processor can electronically transfer a rebate to the factoring company, the entire process can be made transparent to the rebate sponsor. That is, the rapid rebate approach can be practiced without the involvement of rebate sponsors.

Convenience Fee

In another embodiment, the rebate sponsor may simply charge the consumer a fee in exchange for expedited processing and payment of his/her rebate claim. The assessment of a convenience, processing, transaction, or any other fee by the rebate sponsor or its assigns will have the ultimate impact of reducing the amount of money received by the consumer resulting in the consumer receiving less than the original rebate amount (face value). As with purchase of the rebate receivable, this embodiment also avoids the administrative expense typically associated with short-term loan products.

Short-Term Loan

In another embodiment, a financial institution could create a short-term loan facility wherein the rapid rebate is treated like a short-term loan that is securitized by the anticipated rebate payment from the rebate sponsor. In this embodiment, the consumer could be assessed both a finance charge and various loan related fees such as for application processing, with the significant benefit that the consumer is getting paid on an expedited basis for a portion of the face value of the rebate.

Embodiments of the present invention can provide a system and method for constructing the aforementioned various types of rapid rebates and presenting them as disbursement options to consumers seeking rebate redemption. In addition, embodiments of the invention provide many technical advantages. For example,

Significant reduction in overall rebate processing time. One outstanding benefit of the present invention is that when combined with an efficient rebate authorization process, consumers can receive a cash rebate payment in as little as 24 hours or instantly receive an online purchase credit.

Balance between customer satisfaction and industry standard breakage. The rapid rebate disbursement option does not have to be presented to the consumer until after he/she has successfully claimed a rebate (i.e., the starting point of the rebate processing timeline). The availability of a rapid rebate may not necessarily affect a consumer's decision whether to submit a rebate request. What is more, the rapid rebate has no bearing on whether the submission itself will be successful. As a result, breakage may still occur prior to the rapid rebate process.

Avoids the perils of consumer lending. Although a loan can also be used to enable a rapid rebate, the preferred embodiment utilizes a rebate receivable that allows a factoring company to avoid the administrative overhead typically associated with consumer lending.

Other objects and advantages of the present invention will become apparent to one skilled in the art upon reading and understanding the detailed description of the preferred embodiments described herein with reference to the following drawings.

### BRIEF DESCRIPTION OF THE DRAWINGS

A more complete understanding of the present invention and the advantages thereof may be acquired by referring to the following description, taken in conjunction with the accompanying drawings in which like reference numbers indicate like features and wherein:

FIG. 1 is a diagrammatic representation of an overall architecture wherein embodiments of the present invention may be implemented for offering a rapid rebate to a consumer during a rebate processing transaction.

FIG. 2 is a flow diagram illustrating one embodiment of the rapid rebate methodology for providing a rapid rebate to a customer.

FIG. 3 is a diagrammatic representation of a rapid rebate system implementing one embodiment of invention and illustrating in one embodiment the flow between a factoring company and a rebate sponsor.

FIG. 4 is a diagrammatic representation of an implementation of FIG. 1 involving an advertising/cross-sell network in communication with the factoring company and the rebate sponsor for offering advertising/cross-sell option(s) as part of the rapid rebate presented to the consumer during the rebate processing transaction.

FIG. 5 is a diagrammatic representation of a rapid rebate system implementing another embodiment of the invention and illustrating in one embodiment the flow between a factoring company, an advertising/cross-sell network, and a rebate sponsor.

### DETAILED DESCRIPTION

The present invention and various features and advantageous details thereof will now be described with reference to the exemplary, and therefore non-limiting, embodiments that are illustrated in the accompanying drawings. Descriptions of known programming techniques, computer software, hardware, network communications, operating platforms and protocols may be omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

As used herein the following terms have at least the following meanings: “rebate sponsor” refers to any entity, including retailer, distributor, manufacturer, service provider, or other producer or seller of goods and/or services, that offers a consumer a rebate in exchange for the purchase of selective items of goods/services. The term “rebate sponsor” includes the communications and/or processing equipment used or maintained by any such entity. “Merchant” refers to any intermediary, including manufacturers, who enable the sale of products of manufacturer to consumers, including through the Internet and on-line sales, and including the communications and/or processing equipment used or maintained by any such intermediary. “Consumer” refers to any individual or by any entity that purchases a rebate-eligible product (goods and/or services) of a rebate sponsor and includes any communications and/or processing equipment used or maintained by the consumer. Consumers may make purchases from merchants or directly from rebate sponsors. “Network” refers to any collection of components associated with the public switched telephone network, local area networks, wide area networks, a global computer network such as the Internet, the World Wide Web, or any other suitable wireline or wireless communications technology for transmitting voice/data or other information from point to point. Data entry interfaces typically electronically capture data from rebate request forms that are submitted through non-electronic channels. “Network” also refers to physical communication networks where information, collateral, and currency may be exchanged, such as a mail service. For example, a network can include the entities, communications, and processing equipment used to send information and materials back and forth via courier, government mail, or in person. These particular communication channels are examples of physical networks. “Disbursement options” refers to funding choices presented to a consumer and include those designed for assigning the rebate to a buyer (e.g., a factoring company or other financial entities). Within the present disclosure, a disbursement option represents more than just the use of a particular delivery mechanism to get funds or something of value to a consumer and defines:

1. What?—What will the consumer receive? What form will the remuneration be in, and how can this currency be used?

2. Amount/Value?—How much or what is the value of what the consumer will receive?

3. When?—When will the consumer receive the rebate?

4. How?—How will the rebate be sent? How will the remuneration be delivered to the consumer? This is the actual disbursement mechanism (e.g., checks, Automated Clearing House (ACH) payments, prepaid cards, electronic coupons, etc.)

The ACH Network is a nationwide batch-oriented electronic funds transfer system for the interbank clearing of electronic payments for participating depository financial institutions. The Federal Reserve and Electronic Payments Network act as ACH operators, central clearing facilities through which financial institutions transmit or receive ACH entries. ACH payments include, but are not limited to, business-to-business payments, electronic checks, electronic commerce payments, etc.

“Factoring company” refers to any commercial entity that is assigned or that purchases rebate receivables from consumers below par and redeems them for a higher value, thereby engaging in the business of receivables financing. A factoring company can be, but does not have to be, an entity in charge of an embodiment of a rebate network manager as described in the above-referenced U.S. patent application Ser. No. 11/504,122. “Rapid rebate” refers to any expedited cash payment, credit, or anything of value provided to a consumer to purchase the rights to all or a portion of the rebate payment obligation (receivable) created when the consumer submitted a qualifying rebate claim. “Rebate collateral” refers to materials, information, or any combination thereof required by a rebate sponsor to prove that a consumer has made a rebate eligible purchase and is entitled to the associated rebate, including but not limited to the purchase receipt, a unique rebate/transaction code, proof of purchase, product packing labels, invoice, UPC bar code, product model and serial numbers, rebate coupon, rebate claim form, and any other materials or information. “Rebate processing center” or “rebate processor” refers to any combination of people, machinery, buildings, business entity, etc. that process rebates for products/services purchased by consumers using rebate promotions established by rebate sponsors such as manufacturers, distributors, and/or retailers. This can include an internal department of the rebate sponsor, or it may be outsourced to an external service provider. “Rebate receivable” refers to the physical or electronic deed or assignment of rights to a cash payment for a product rebate for which a rebate claim has been authorized by the designated rebate processor but the payment has not been processed.

Embodiments of the invention have the following features: Accelerated rebate disbursement at less than face value. In contrast to other rebate processing systems, which explicitly contemplate non-cash rebate disbursement options that are greater than the cash value of the rebate, the Rapid Rebate solution disclosed herein can present a cash disbursement option that pays the consumer less than the original, face value of the rebate. Here, the word cash is used to refer to cash or cash equivalents that, unlike store credits, do not have any rebate-related restrictions on where the funds may be used. This can be accomplished through a variety of mechanisms as illustrated in Table 1 below.

TABLE 1
Examples of Rebate “Disbursement” Options for a $50 Rebate.

| | | Amount/ | | |
|---|---|---|---|---|
| What? | | Value? | When? | How? |
| I. | Cash from | $50 | 8-12 | Check by mail |
| | Rebate | | weeks | |
| | Sponsor | | | |
| II. | Cash from | $50 | 8-12 | Pre-paid debit card by |
| | Rebate | | weeks | mail |
| | Sponsor | | | |
| III. | Manufacturer | $60 | 4-6 weeks | Printable gift certificate |
| | Purchase | | | |
| | Credit | | | |
| IV. | Cash from | $45 | Next | Direct deposit into |
| | Rapid Rebate | | business day | designated bank account |
| | | | | or credit card credit |
| V. | Cash from | $45 | 2-3 business | Check by mail |
| | Rapid Rebate | | days | |

As Table 1 illustrates, the Rapid Rebate solution disclosed herein enables several fundamentally novel “disbursement options” (e.g., Options IV and V) that give each consumer a proactive and accelerated option of paying a portion of the rebate, resulting in the consumer receiving less than the face value of the authorized rebate but in a significantly reduced timeframe (i.e., from up to 12 weeks down to the next business day). Less (e.g., instant) disbursement time is possible and could be arranged in proportion to the convenience fee deducted from the rebate amount (e.g., a consumer may pay more than 10% of the face value to have the rebate disbursed in less than 24 hours). Additionally, the Rapid Rebate solution disclosed herein can include disbursement options that may offer cash or credit in amounts equal to and/or more than the face value of the rebate.

Assignable Rebate Receivables.

In one embodiment, the Rapid Rebate solution disclosed herein enables the creation of assignable rebate receivables. More specifically, after a rebate claim has been authorized by the rebate processor, one embodiment of the invention operates to automatically create a rebate receivable account in the consumer's name at an authorized financial institution or factoring company where the rebate processor can forward the rebate sponsor's rebate payment. Regardless of whether the rebate is assignable, the rebate receivable can be assigned, sold, or transferred to a 3^{rd} party. The creation as well as use of a rebate receivable is believed to be another novel feature of the present invention.

Electronic Purchase Agreement.

In one embodiment, a purchase agreement signed electronically by the consumer will assign the rights to his/her rebate to the purchaser upon payment of the agreed upon purchase price. Per the Electronic Signature Act, electronic contracts and electronic records relating to such contracts have become pervasive, and should be known to anyone familiar with the art. The most popular electronic signature technologies include digital signatures that leverage public key cryptography, passwords, clickwrap signatures (e.g., an “I Accept” button on a website), and biometric signatures (e.g., voice prints and fingerprints). Over time, these electronic signature technologies may change, but the ultimate objective is to allow someone to enter into what is recognized as a legally binding contract remotely using electronic communication. The rebate receivable that can be assigned, sold, or transferred to a 3^{rd} party via an electronically-signed purchase agreement is believed to be yet another novel feature of the present invention.

Automated Account Creation and/or Designation.

In addition to a rebate receivable, in one embodiment, if the rebate is assignable, the purchaser or buyer of the rebate receivable (e.g., a factoring company) can designate an account into which the rebate sponsor's rebate payment is to be transferred. Specifically, after the rebate is authorized by the rebate processing center (RPC), the RPC and/or the rebate network manager can determine the set of disbursement options that are to be presented to the customer. The RPC can then display this set of options to the consumer, who is to select the disbursement option that they find most attractive. If a rapid rebate is selected, the RPC may operate to present the Electronic Purchase Agreement to the consumer, including all of the terms and conditions associated with the rapid rebate. If more than one option for how the consumer may receive his/her rapid rebate is given, the consumer is advised to choose how he/she would like to receive his/her rapid rebate payment, and to provide the required disbursement information for that disbursement mechanism (e.g., if the customer chooses a direct deposit, he/she is asked to provide the routing transit number and account number for his/her checking account.) In embodiments where a rebate network manager is implemented as a separate entity, the RPC may operate to communicate the rebate authorization, the electronic purchase agreement confirmation, and the rapid rebate disbursement data, collectively, and the rapid rebate request to the rebate network manager. The RPC or the rebate network manager then communicates all the information to the appropriate factoring company. If a rebate network manager is not implemented, the RPC can send the information directly to the factoring company.

Alternatively, the rebate network manager may play the role of the factoring company itself. The rapid rebate requests can be sent in real-time, or they can be batched and sent multiple times per day. The components of the rapid rebate request—rebate authorization, electronic purchase agreement, and rapid rebate disbursement data—can be combined into one electronic communication or they can be separate communications that all contain the same rebate authorization code.

The RPC may also send an electronic message to the consumer confirming his/her rebate disbursement option selection and reiterating the terms of the agreement. Upon receiving the aforementioned data, the factoring company can perform a series of diagnostic/validation checks to make sure that the data received is in appropriate format and not corrupted. This diagnostic/validation process can include checking to make sure that the rebate authorization code is not a duplicate, checking the consumer's name and address for alpha/numeric characters, and checking the RTN and account number provided by the consumer for numeric characters. If all of these checks are valid, the factoring company can initiate a payment consistent with the rapid rebate disbursement option selected by the consumer.

The factoring company can then send a rapid rebate payment confirmation back to the RPC that can include the data required for the RPC to electronically present payment status and tracking information to the consumer (e.g., an ACH confirmation code or check number) along with the designated disbursement account information for the rebate sponsor's rebate payment. The tracking information allows the consumer to return to the RPC's Website or call the RPC to inquire about the status of the rapid rebate payment. The automated mechanism employed for the creation of an account in the consumer's name specifically for the purpose of receiving a consumer rebate and for the communication of the designated account information is believed to be another novel feature of the present invention.

Unconventional Rebate Payee.

Traditionally, rebate payments are sent directly to the qualified rebate recipients. In embodiments of the invention, an original rebate payment can be sent to an authorized financial institution rather than directly to the consumer. Specifically, in embodiments of the invention, if a customer chooses to receive a rapid rebate, the original rebate payment can be forwarded to the factoring company that purchased the rebate receivable, or it can be deposited into the newly created account. For example, once payment of the invoice for the authorized rebate has been received from or cleared by the rebate sponsor, the RPC can make an ACH payment into the account designated by the factoring company. In those cases where the rebate is not assignable, the invention provisions for the creation of a receivable account in the consumer's name at an authorized financial institution or factoring company where the RPC can forward the rebate sponsor's rebate payment. In the loan scenario, once the funds have been deposited into the consumer's rebate receivable account, consistent with the electronically signed loan application, the authorized financial institution can automatically apply the funds as payment of the consumer's rebate loan. If there is an outstanding credit on the account (e.g., if the rebate sponsor's payment is greater than the amount agreed upon in the electronic loan application), the factoring company can disburse the remaining credit to the consumer using the disbursement information already received, and subsequently close the zero balance account.

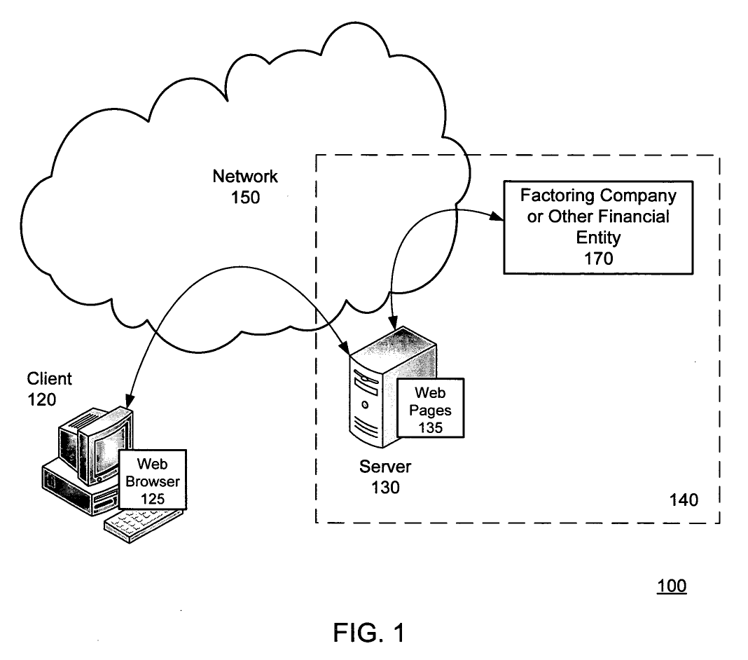

FIG. 1 is a diagrammatic representation of an overall architecture wherein embodiments of the present invention may be implemented for offering a rapid rebate to a consumer during a rebate processing transaction. It should be understood that the following description is only exemplary and provides some examples of how the processing of a rebate can occur and how embodiments of the invention can be implemented in a network environment. In the example shown in FIG. 1, a system 100 for creating and presenting rapid rebates as disbursement options to a qualified rebate recipient may comprise at least one client 120 representative of a first party in communication with a second party represented by a server 130 over a network 150 (e.g., the Internet). In one embodiment, client 120 is representative of a consumer and server 130 is representative of a rebate processing center (RPC). In one embodiment, system 100 further comprises a factoring company or other types of financial entity 170. In one embodiment, system 100 comprises an extended RPC 140 which integrates the functionality of both RPC 130 and factoring company 170. In some embodiments, RPC 130 or RPC 140 may be an independent company or an agent or operator of a rebate sponsor (not shown).

The term rebate sponsor is representative of any manufacturer or retailer that offers rebate programs for the purchase of select products. Customers who purchased the select products are eligible to apply for corresponding rebates and can initiate the rebate claim process by mail or via Web Browser 125 running on client 120 and Web Pages 135 running on server 130.

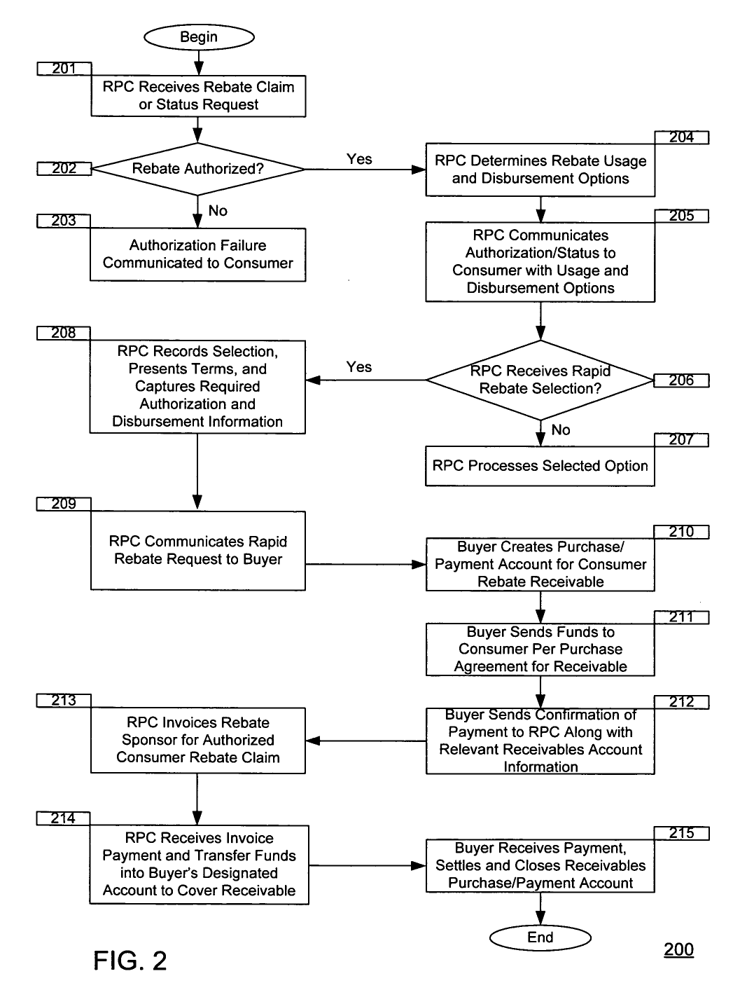

FIG. 2 is a flow diagram illustrating one embodiment of the rapid rebate methodology for providing a rapid rebate to a customer. In the example shown in FIG. 2, a flow 200 begins at step 201 when the RPC receives a rebate claim or a status request thereof from the consumer.

At step 202, the RPC operates to determine whether the rebate claim is authorized. The rebate processing center determines if the consumer has made a rebate eligible purchase by validating the submitted collateral against the terms and conditions defined by the rebate sponsor for the relevant promotion, or in the case of a status request, locates and determines the associated status of a designated rebate claim.

At step 203, if the rebate claim is not authorized by the rebate processor (i.e., the RPC), an authorization failure message is communicated to the consumer.

At step 204, if the rebate claim is authorized, the RPC determines the status, next steps, and relevant rebate usage and disbursement options accordingly.

At step 205, the RPC communicates the status of the rebate claim, required next steps (if any), relevant rebate usage and disbursement options to the consumer. The rebate processor may ask the consumer to select at least one disbursement option.

At step 206, the RPC operates to determine whether the usage and disbursement option selection(s) is received from the consumer.

At step 207, if the consumer has not selected the rapid rebate option, the RPC proceeds to process, consistent with its standard process, the usage and disbursement option that the consumer has selected.

At step 208, if the consumer selected a rapid rebate, the RPC records the selection, present corresponding terms and applicable rules to the consumers, and captures all the required information including the authorization and disbursement information.

At step 209, after the consumer has satisfied all of the promotion requirements, and the rebate has been authorized by the RPC, the RPC forwards the rapid rebate request, inclusive of confirmation of rebate authorization and an electronically signed purchase agreement to the factoring company (i.e., the buyer). If the original rebate is not paid, the confirmation of rebate authorization and signed purchase agreement can be used as legal proof of the rebate receivable.

At step 210, the factoring company creates/opens a unique purchase/payment account for the consumer.

At step 211, the factoring company disburses the purchase price of the rebate receivable to the consumer per the purchase agreement.

At step 212, the factoring company sends a conformation of payment to the RPC along with relevant information (e.g., consumer name, account number, rebate program number, payment amount, etc.) associated with the designated rebate receivable account.

At step 213, after authorizing the consumer's rebate claim, the RPC operates to generate and send an invoice to the rebate sponsor for the full authorized amount of the rebate claim.

At step 214, after receiving the invoice payment from the rebate sponsor, the RPC electronically transfers the agreed amount into the designated rebate receivable account to cover the receivable that the factoring company had purchased.

At step 215, after receiving the receivable payment from the RPC, the factoring company settles the outstanding balance on the rebate receivable account, and closes the purchase/payment account, concluding flow 200.

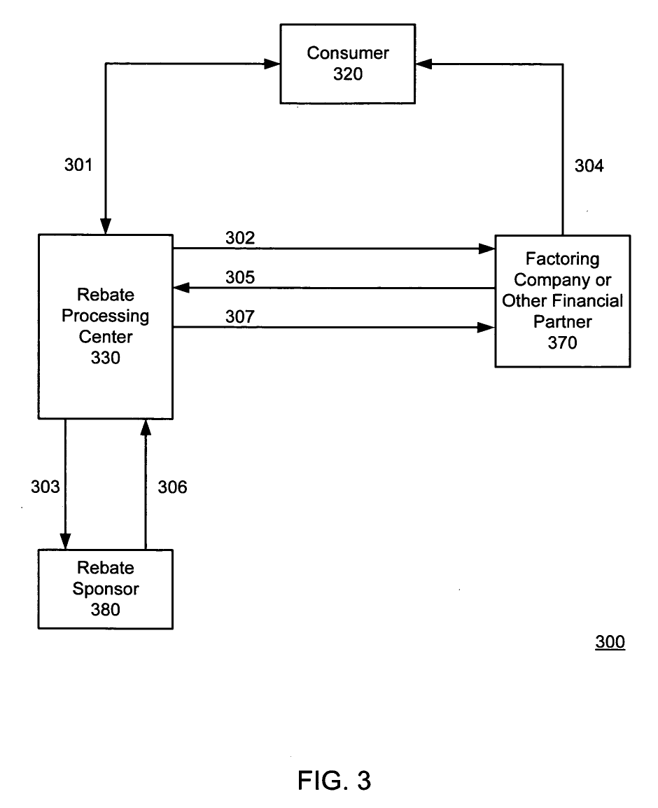

FIG. 3 is a diagrammatic representation of a rapid rebate system 300 implementing one embodiment of invention and illustrating in one embodiment the flow between a factoring company and a rebate sponsor. In the example shown in FIG. 3, system 300 comprises a consumer 320, a RPC 330 communicatively coupled to consumer 320, a factoring company 370 communicatively coupled to consumer 320 and RPC 330, and a rebate sponsor 380 communicatively coupled to RPC 330. As one skilled in the art can appreciate, communications among consumer 320, RPC 330, factoring company 370, and rebate sponsor 380 can occur in a distributed computing environment such as the Internet.

In one embodiment, an accelerated rapid rebate processing timeline may begin at step 301 which, upon the authorization of a rebate claim submitted by consumer 320, RPC 330 operates to prepare rapid rebates appropriate for the rebate claim and send a confirmation or rebate authorization along with applicable rapid rebates to consumer 320 as disbursement options. In this case, consumer 320 selects a rapid rebate and communicates the selection to RPC 330 (e.g., by clicking on an “accept” button associated with the rapid rebate selection on a Web page 135 hosted by server 130 and presented to consumer 320 via Web browser 125 at client 120).

At step 302, RPC 330 operates to prepare and send a request pertaining to the selected rapid rebate to factoring company 370. In one embodiment, the request may contain the rebate authorization, an electronic purchase agreement, and disbursement data.

At step 303, RPC 330 operates to generate and send an invoice to rebate sponsor 380. Such an invoice would reference the authorized rebate and advise rebate sponsor 380 of the amount due, among other standard items such as date and payment terms.

At step 304, after analyzing and verifying the request from RPC 330, factoring company 370 releases appropriate fund and pays consumer 320 the rapid rebate per the disbursement data received from RPC 330. Using Table 1 as an example, if option IV is selected, factoring company 370 may make a direct deposit of $45 into a bank account provided by consumer 320 or credit $45 to a credit card account specified by consumer 320. Prior to paying consumer 320 or at about the same time, factoring company 370 may operate to generate a rebate receivable account associated with the disbursement and designated to collect the original rebate payment from rebate sponsor 380 and forwarded by RPC 330. As one skilled in the art can appreciate, steps 301-304 may occur in real-time, within a 24-hour period or less, or just a few days. As described above, in the traditional rebate processing timeline, if all goes well, it generally takes 6-10 weeks before a rebate check is cut and sent to a qualified rebate recipient. Comparable to the traditional rebate processing timeline which begins when a rebate claim is authorized and ends when a payment corresponding to the rebate claim is sent, steps 301-304 thus illustrate how embodiments of the invention can enable a consumer to redeem a rebate in significantly less time at a cost deducted from a fraction of the total rebate amount.

At step 305, factoring company 370 prepares and sends a confirmation message to RPC 330. Such a confirmation message may contain the corresponding rebate authorization (e.g., a unique identification code), data confirming the rapid rebate payment to consumer 320, and the designated rebate receivable account information. Step 305 may occur soon after step 304 or at about the same time.

After invoicing rebate sponsor 380 at step 303, it may take 4-6 weeks for RPC 330 to receive, at step 306, the corresponding payment for the authorized rebate. As one skilled in the art will know, transactions (e.g., invoicing, payment processing, etc.) between RPC 330 and rebate sponsor 380 may occur in batches.

At step 307, RPC 330 operates to send the rebate payment to factoring company 370 and perhaps closes the loop.

As illustrated in FIG. 3, there could be no direct relationship between rebate sponsor 380 and consumer 320 or between rebate sponsor 380 and factoring company 370. In one embodiment, the invoice from RPC 330 needs not indicate the disbursement choice (e.g., a rapid rebate) made by consumer 320. Rebate sponsor 380 is obliged to fulfill the qualified rebate claim submitted by consumer 320 and invoiced by RPC 330. So long as the obligation to pay the invoice is satisfied, there is no need for rebate sponsor 380 to be involved in the rapid rebate process. Thus, in one embodiment, transactions pertaining to the rapid rebate can be completely transparent to rebate sponsor 380. In another embodiment, it is possible to implement RPC 330 as a built-in functionality that is part of a Website operated by rebate sponsor 380, in which case, steps 303 and 306 may be internal to rebate sponsor 380 or otherwise eliminated. Alternatively, RPC 330 may incorporate the functionality of factoring company 370, in which case, all or part of steps 302, 305, and 307 may be eliminated.

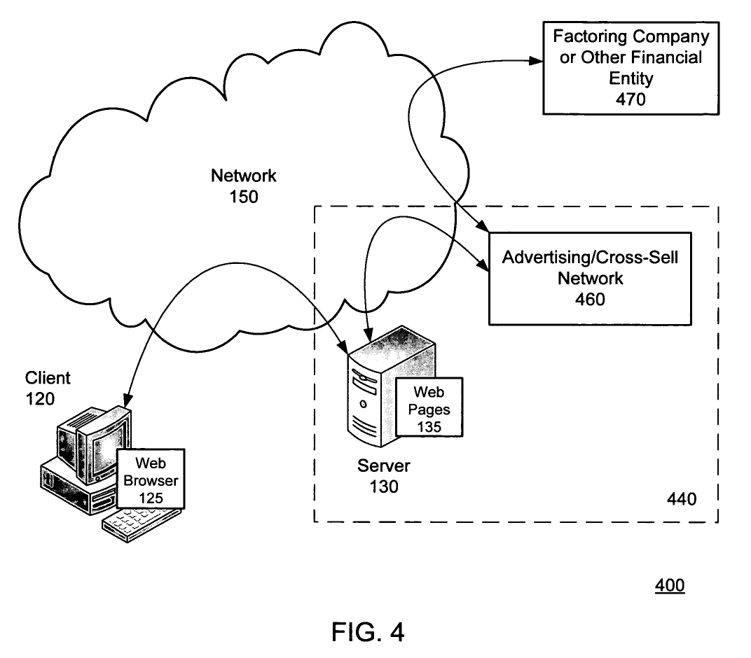

FIG. 4 is a diagrammatic representation of an implementation of FIG. 1 involving an advertising/cross-sell network in communication with the factoring company and the rebate sponsor for offering advertising/cross-sell option(s) as part of the rapid rebate presented to the consumer during the rebate processing transaction. In the example shown in FIG. 4, a rapid rebate system 400 may comprise an advertising/cross-sell network 460. Specific examples of cross-sell network 460 can be found in the above-referenced U.S. patent application Ser. No. 11/504,122. Rebate cross-sell network 440 represents one embodiment of the invention which integrates the functionality of RPC 130 and the ability to cross-sell products/services through the rebate processing network. In system 400, communications to factoring company 470 can be done through a rebate cross-sell network manager, which may reside on a server machine in rebate cross-sell network 440. Similar to the example shown in FIG. 1, system 400 comprises computers programmed with appropriate software instructions which are generally carried on computer-readable media and which are executable by central processing units of the computers. When executed, these software instructions operate to perform the steps described herein so as to realize embodiments of the rapid rebate solution disclosed herein. The necessary programming techniques and computer languages to achieve this are known to those skilled in the art and thus not further described here.

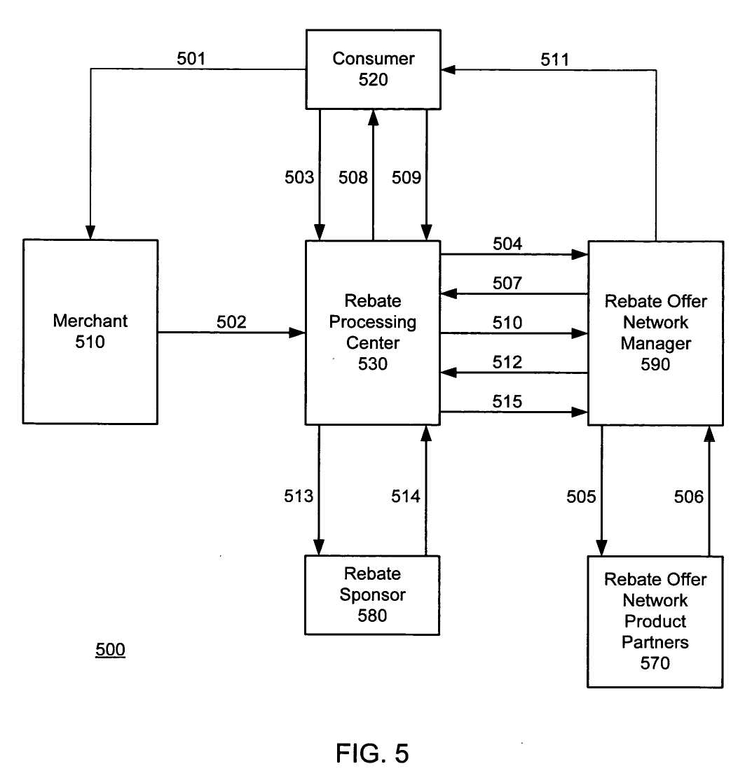

FIG. 5 illustrates a flow diagram of another embodiment of the performing a rapid rebate transaction using, for example, the system of FIG. 1.

FIG. 5 is a diagrammatic representation of a rapid rebate system 500 implementing another embodiment of invention and illustrating in one embodiment performing a rapid rebate transaction between a factoring company, an advertising/cross-sell network, and a rebate sponsor. In the example shown in FIG. 5, a consumer 520 makes a purchase of a rebate-qualifying product or service from a merchant 510 who sponsors the rebate program for the product or service (step 501).

Merchant 510 reports the rebate-eligible purchase to RPC 530 (step 502). This communication may occur over a network (e.g., network 150 of FIG. 1) and may occur in real-time or as part of a batch transaction.

Consumer 520 can then initiate a rebate reimbursement transaction (e.g., via an online session over network 150 of FIG. 1) with RPC 530 (step 503). Consumer 520 may provide personal information (e.g., name, email address, etc.) as well as rebate eligibility collateral to RPC 530.

Similar to RPC 130 of FIG. 1 and FIG. 4, RPC 530 may be responsible for creating and/or managing the primary product (product for which the rebate is being provided to consumer 520) rebate program. RPC 530 may be implemented as a Web-based online service center accessible to consumer 520 through the global communications network (Internet), for example, through a URL entered at consumer 520's browser application. RPC 530, among other functions, can be configured to fulfill the primary product rebate, manage rebate fraud, provide payment facility/mechanism for the primary product rebate, disburse the primary product rebate, and manage campaigns designed to drive consumers to use its Web-based rebate functionality. As an example, RPC 530 may be programmed to electronically accept the rebate claim data from consumer 520 and send a rebate offer query to a rebate network manager or network manager 590 (step 504).

In this embodiment, network manager 590 is programmed to interface between RPC 530 and rebate offer network product partners 570 (e.g., factoring company 470). More specifically, network manager 590 is programmed to perform a plurality of functions including, among others, establishing and managing the relationships between rebate sponsors, rebate processing centers and merchants/retailers, tracking and reporting offers made/accepted by consumers, managing the performance based payments (e.g., managing payments from partners 570 to consumer 520, etc.) and, should consumer 520 chooses to receive a rapid rebate instead of the original rebate, accepting the original rebate as a receivable.

After receiving the rebate offer query from RPC 530, network manager 590 operates to formulate and send a structured query to partners 570 to acquire initiate leads and cross-sell opportunities from partners 570 (step 505).

In response, rebate offer network product partners 570 returns rapid rebate offer(s) which are in addition to the original rebate offered to the consumer and which may also include cross-sell offers (step 506).

At step 507, network manager 590 returns the rapid rebate offers to RPC 530 for forwarding to consumer 520 at step 508. Alternatively, this interaction with consumer 520 could be conducted by network manager 590 directly and the outcome reported to RPC 530. Further, it should be understood that in alternative embodiments, the functionality of network manager 590 can be partially or fully integrated with RPC 530, rebate sponsor 580, or even distributed to work station(s) of consumer 520. Additionally, as described above with reference to FIGS. 1-3, embodiments of the rapid rebate solution disclosed herein can be practiced without network manager 590. One distinguishing feature of the rapid rebate solution disclosed herein is directed to offering a rapid rebate to a consumer during a rebate processing session. Another distinguishing feature of the rapid rebate solution disclosed herein is that the rapid rebate(s) offered to the consumer may include a secondary product offering(s).

At step 508, consumer 520 is presented with the rapid rebate option(s), which may include cross-sell offers. Consumer 520 can choose to wait or expedite the rebate process by accepting a rapid rebate.

At step 509, the selection is communicated to RPC 530. If consumer 520 decides to forego the rapid rebate option(s), RPC 530 operates to process the rebate as it would have without the rapid rebate option(s).

At step 510, if consumer 520 decides to accept a rapid rebate option, a message is constructed and sent to network manager 590 indicating consumer 520's acceptance of the rapid rebate option. As discussed above, the rapid rebate option can include a cash payment of less than the original rebate amount to consumer 520 in exchange for assigning the rebate collection opportunity to, for example, network manager 590 in this embodiment. Using Table 1 as an example, suppose consumer 520 is qualified to receive a rebate of $50 for a primary product purchased from merchant 510 and made by rebate sponsor 580. If consumer 520 selects the disbursement option IV, $45 can be immediately deposited into consumer 520's bank account. If consumer 520 selects the disbursement option V, $45 can be immediately credited to consumer 520's credit card. The following references relate generally to systems and methods for performing some rebate processing functions (e.g., on-line credit reviews, approval of credit applicants, credit processing, credit card reservations and processing, providing on-line credit card applications and instant issuance of credit cards), all of which are hereby incorporated by reference herein in their entirety: U.S. Pat. No. 6,877,656 by Jaros et al., U.S. Pat. No. 6,795,812 by Lent et al., U.S. Pat. No. 6,405,181 by Lent et al., U.S. Pat. No. 6,144,948 and U.S. Pat. No. 6,088,686 by Walker et al., U.S. Pat. No. 6,014,645 by Cunningham, U.S. Pat. No. 6,029,149 by Dykstra et al., U.S. Pat. No. 5,963,921 by Longfield, U.S. Pat. No. 6,847,935 by Solomon et al., U.S. Pat. No. 6,865,544 by Austin, and U.S. Pat. No. 5,729,693 by Holda-Fleck; and U.S. Patent Application Publication No. 2004/0251305 by Klapka et al.

At step 511, network manager 590 provides payment to consumer 520 for the amount of the rapid rebate. This can be accomplished either through RPC 530 or directly by network manager 590 (e.g., deposit the payment into a checking account, immediate debit card, etc.).

Steps 512-515 do not involve consumer 520. At step 512, network manager 590 operates to inform RPC 530 that payment to consumer 520 has been satisfied. At step 513, RPC 530 notifies rebate sponsor 580 that the rebate to consumer 520 has been satisfied and invoices rebate sponsor 580 for the full rebate amount. At step 514, rebate sponsor 580 remits the invoiced amount to RPC 530. At step 515, RPC 530 forwards the rebate payment to network manager 590.

Alternatively, if consumer 520 chooses a rapid rebate option, RPC 530 could be taken out of the above-described process altogether and steps 510-515 can occur directly between network manager 590, consumer 520, and rebate sponsor 580.

Although the present invention has been described in detail herein with reference to the illustrative embodiments, it should be understood that the description is by way of example only and is not to be construed in a limiting sense. It is to be further understood, therefore, that numerous changes in the details of the embodiments of this invention and additional embodiments of this invention will be apparent to, and may be made by, persons of ordinary skill in the art having reference to this description. Accordingly, the scope of the invention should be determined by the following claims and their legal equivalents.

What is claimed is:

1. An accelerated rebate processing method, comprising:
determining disbursement options for an authorized rebate, wherein said disbursement options include one or more rapid rebates, each of which is less than said authorized rebate;
presenting said disbursement options to a consumer;
receiving a response from said consumer indicating a selection of a rapid rebate; and
sending a rebate payment corresponding to said rapid rebate to said consumer, wherein said rebate payment fulfills said authorized rebate.

2. The accelerated rebate processing method of claim 1, wherein said sending step occurs within about 24 hours or less from said receiving step.

3. The accelerated rebate processing method of claim 1, wherein said sending step occurs within about 48 hours or less after receiving a confirmation of rebate authorization.

4. The accelerated rebate processing method of claim 1, wherein said rapid rebate enables a buyer to purchase said authorized rebate from said consumer as a rebate receivable, wherein said rapid rebate enables said consumer to enter into an electronic purchase agreement with said buyer, and wherein said buyer sends said rebate payment to said consumer per said electronic purchase agreement.

5. The accelerated rebate processing method of claim 1, further comprising:
assessing a convenience fee, a finance charge, a short-term loan application fee, or a combination thereof for said rapid rebate.

6. The accelerated rebate processing method of claim 1, wherein sending a rebate payment to said consumer comprises making a direct deposit into an account designated by said consumer, mailing a paper check or pre-paid card to said consumer, or crediting said consumer's credit or debit card.

7. The accelerated rebate processing method of claim 1, further comprising:
recording said selection of said rapid rebate;
presenting terms and conditions of said rapid rebate to said consumer;
capturing information pertaining to said consumer, said authorized rebate, and said rapid rebate;
formulating a rapid rebate request based on captured information; and
communicating said rapid rebate request to a factoring company.

8. The accelerated rebate processing method of claim 1, further comprising:
creating a designated rebate receivable purchase/payment account.

9. The accelerated rebate processing method of claim 8, further comprising:
sending confirmation of said rebate payment and account information for said designated rebate receivable purchase/payment account to a rebate processor or network manager.

10. The accelerated rebate processing method of claim 8, further comprising:
invoicing a rebate sponsor for said authorized rebate;
receiving an invoice payment for said authorized rebate; and
forwarding said invoice payment for said authorized rebate into said designated rebate receivable purchase/payment account.

11. A computer-readable medium carrying computer-executable instructions translatable to perform an accelerated rebate processing method comprising the steps of:
determining disbursement options for an authorized rebate, wherein said disbursement options include one or more rapid rebates, each of which is less than said authorized rebate;
presenting said disbursement options to a consumer;
receiving a response from said consumer indicating a selection of a rapid rebate; and
sending a rebate payment corresponding to said rapid rebate to said consumer, wherein said rebate payment fulfills said authorized rebate.

12. The computer-readable medium of claim 11, wherein said rapid rebate enables a buyer to purchase said authorized rebate from said consumer as a rebate receivable, wherein said rapid rebate enables said consumer to enter into an electronic purchase agreement with said buyer, and wherein said buyer sends said rebate payment to said consumer per said electronic purchase agreement.

13. The computer-readable medium of claim 11, wherein said accelerated rebate processing method further comprises assessing a convenience fee, a finance charge, a short-term loan application fee, or a combination thereof for said rapid rebate.

14. The computer-readable medium of claim 11, wherein said accelerated rebate processing method further comprises:
recording said selection of said rapid rebate;
presenting terms and conditions of said rapid rebate to said consumer;
capturing information pertaining to said consumer, said authorized rebate, and said rapid rebate;
formulating a rapid rebate request based on captured information; and
communicating said rapid rebate request to a factoring company.

15. The computer-readable medium of claim 11, wherein said accelerated rebate processing method further comprises:
creating a designated rebate receivable purchase/payment account.

16. The computer-readable medium of claim 15, wherein said accelerated rebate processing method further comprises:
sending confirmation of said rebate payment and account information for said designated rebate receivable purchase/payment account to a rebate processor or network manager.

17. The computer-readable medium of claim 15, wherein said accelerated rebate processing method further comprises:
invoicing a rebate sponsor for said authorized rebate;
receiving an invoice payment for said authorized rebate; and
forwarding said invoice payment for said authorized rebate into said designated rebate receivable purchase/payment account.

18. A system for processing accelerated rebates, comprising:
a rebate processor communicatively coupled to a network and at least one factoring company, wherein said rebate processor is operable to
receive a rebate claim or a status request thereof from a consumer over said network;
determine whether said rebate claim is authorized;
if said rebate claim is not authorized, communicate authorization failure to said consumer;
if said rebate claim is authorized, determine disbursement options which include one or more rapid rebates, each of which is less than said authorized rebate;
present said disbursement options to said consumer;
receive a selection from said consumer;
if said selection indicates an acceptance of a rapid rebate, formulate a rapid rebate request pertaining to said rapid rebate and communicate said rapid rebate request to said factoring company, wherein said rapid rebate enables said consumer to enter into an electronic purchase agreement with said factoring company; and
wherein said factoring company is operable to send a rebate payment corresponding to said rapid rebate to said consumer per said electronic purchase agreement and wherein said rebate payment fulfills said rebate claim.

19. The system of claim 18, wherein said rapid rebate enables said factoring company to purchase said authorized rebate from said consumer as a rebate receivable at an amount less than said rebate claim or to access a convenience fee, a finance charge, a short-term loan application fee, or a combination thereof to said consumer in exchange for sending said rebate payment within about 24 hours or less.

20. The system of claim 18, wherein said rebate processor is further operable to
record said selection of said rapid rebate;
present terms and conditions of said rapid rebate to said consumer;
capture information pertaining to said consumer, said rebate claim, and said rapid rebate;
formulate said rapid rebate request based on captured information;
invoice a rebate sponsor for said rebate claim;
receive an invoice payment for said rebate claim; and
forward said invoice payment into a rebate receivable purchase/payment account designated by said factoring company.
